(19) United States
(12) Patent Application Publication
(10) Pub. No.: US 2015/0057209 A1
(43) Pub. Date: Feb. 26, 2015

(54) ABRASIVE GRAIN, POLISHER, AND PRODUCTION METHOD OF ABRASIVE GRAIN

(71) Applicants: Kiyotaka Sawada, Atsugi-shi (JP); Jun Zhang, Tokyo (JP); Satoshi Kai, Atsugi-shi (JP); Takuya Kohda, Atsugi-shi (JP); Yangyang Dai, Shanghai (CN)

(72) Inventors: Kiyotaka Sawada, Atsugi-shi (JP); Jun Zhang, Tokyo (JP); Satoshi Kai, Atsugi-shi (JP); Takuya Kohda, Atsugi-shi (JP); Yangyang Dai, Shanghai (CN)

(73) Assignee: RICOH COMPANY, LTD., Tokyo (JP)

(21) Appl. No.: 14/463,734

(22) Filed: Aug. 20, 2014

(30) Foreign Application Priority Data
Aug. 21, 2013 (JP) 2013-171678

(51) Int. Cl. C11D 11/00; C11D 17/06

(52) U.S. Cl. CPC C11D 11/0035; C11D 17/06
USPC 510/180

(57) ABSTRACT

An abrasive grain includes a granular porous body in which many primary grains are bonded with each other partially, and in a state where pores are formed, and a functionalizing material which is constituted of a material which is different from the primary grains is contained within the abrasive grain.

### CROSS-REFERENCE TO RELATED APPLICATIONS

The present application is based on and claims priority from Japanese Patent Application Number 2013-171678, filed Aug. 21, 2013, the disclosure of which is hereby incorporated by reference herein in its entirety.

### BACKGROUND

The present invention relates to an abrasive grain for polishing purposes (including a cleaning purpose), a polisher on a polishing surface of which the abrasive grain is fixed, and a production method of such an abrasive grain.

On a surface of a mirror (glass) in a bathroom, a washroom, or the like, cookware, a tap, a bathtub, a sink, various types of window glasses, a glass door, various types of lights of vehicles such as an automobile, and the like, a water stain deposits as a result of contact with water. Above all, in particular, a main component of the water stain on the surface of the mirror (glass) in the bathroom is calcium carbonate or silicon dioxide which is deposited from water, and therefore, it is very tough to remove it.

Here, when removal of a water stain on a surface of a mirror, or glass is performed by using a cleaning liquid of sodium hydrogen carbonate, citric acid, or the like and a sponge, which is proposed in Japanese Patent Application Publication No. 2011-231135, calcium carbonate as one of the main components of the water stain is dissolved, and therefore, it is easy to remove the water stain. This is because a carbonic acid component generated by a chemical action of the sodium hydrogen carbonate and citric acid in a cleaning agent dissolves calcium carbonate.

However, although with such a mechanism, an effect of softening and dissolving the water stain is obtained to some degree, in a case where a water stain is thick, and in a so-called scale-like state in which the water stain runs over with glass, or the like, there may be a case where complete removal is difficult by scrubbing cleaning with a sponge.

On the other hand, in a case where removal of a water stain on a surface of a mirror, or glass is performed by using a commercially available sandpaper, there may be a case where the surface of the mirror (glass) is scratched. This is because the hardness of an abrasive grain used for the sandpaper is extremely high.

Additionally, Japanese Patent No. 3990936, and Japanese patent Application Publication No. 2004-261945 (Japanese Patent No. 4301434) relate to an abrasive grain constituted of a granular porous body in which many primary grains are bonded with each other partially and in a state where pores are formed, and a polisher for glass or a silicon wafer as an object to be polished. However, in a case of using the techniques disclosed in the above documents, there is a case where the removal of the water stain on the surface of the mirror or glass is not sufficient due to excessive wear of the abrasive grain.

For example, as shown in model form in FIG. 1, tough water stains (stains) 11 attached to a surface of glass 10 protrude from the surface of the glass 10. Additionally, hardness of carbonate calcium, silicon dioxide, or the like as a main component of the water stains is high, and therefore, there is a case where abrasion of the abrasive grain disclosed in the above documents is accelerated and the abrasive grain is destroyed, as shown in the optical microscope photograph in FIG. 2. When cleaning a glass surface to which such hard water stains are attached, as if the water stains behave as a tool (dresser) having diamond or the like on the surface, the abrasive grain as disclosed in Japanese Patent No. 3990936, and Japanese patent Application Publication No. 2004-261945 (Japanese Patent No. 4301434) is rapidly abraded. Therefore, incision of the abrasive grain onto the glass surface or the water stains becomes weak, and accordingly, machining efficiency lowers, and there may be a case where sufficient removal performance is not obtained.

### SUMMARY

An object of the present invention is to provide an abrasive grain which easily removes with a small force a tough stain such as a water stain attached to glass which is difficult to be cleaned or removed by a conventional cleaning agent or polisher, and at the same time, makes it possible to realize a polisher which does not cause scratching of a glass base material as a ground by cleaning.

The abrasive grain according to an embodiment of the present invention is an abrasive grain constituted of a granular porous body in which many primary grains are bonded with each other partially and in a state where pores are formed, and within the abrasive grain, a functionalizing material of a different material from the primary grains is contained.

In order to achieve the above object, an embodiment of the present invention provides an abrasive grain, comprising a granular porous body in which many primary grains are bonded with each other partially, and in a state where pores are formed, wherein a functionalizing material constituted of a material different from the primary grains is contained within the abrasive grain.

### BRIEF DESCRIPTION OF THE DRAWINGS

FIG. 1 is a model diagram showing a state of polishing water stains attached to a surface of glass by a polisher on a surface of which abrasive grains are fixed.

FIG. 2 is a photograph taken by an optical microscope showing a state of abrasive grains according to a conventional technique used for removal of a water stain.

FIG. 3 is a model explanatory diagram of a granular porous body used for an abrasive grain according to an embodiment of the present invention.

Each of FIGS. 4A and 4B is a diagram showing in model form a use state of an abrasive grain according to the embodiment of the present invention.

Each of FIGS. 5A and 5B is a model diagram showing a production method of an abrasive grain according to the embodiment of the present invention.

FIG. 6 is a model cross-sectional diagram showing an example of a polishing film on a surface of which abrasive grains according to the embodiment of the present invention are fixed.

FIG. 7 is a model cross-sectional diagram showing another example of a polishing film on a surface of which abrasive grains according to the embodiment of the present invention are fixed.

FIG. 8 is a model cross-sectional diagram showing still another example of a polishing film on a surface of which abrasive grains according to the embodiment of the present invention are fixed.

FIG. 9A is a photograph showing a state of a mirror before polishing in examples.

FIG. 9B is a photograph showing a state of the mirror after polishing in the examples.

### DETAILED DESCRIPTION OF THE PREFERRED EMBODIMENTS

Hereinafter, abrasive grains, polishers, and production methods of the abrasive grains according to embodiments of the present invention will be explained with reference to the drawings.

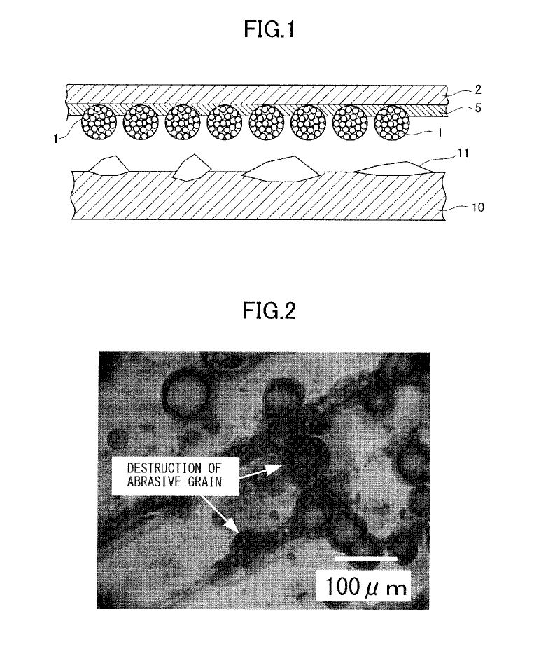

FIG. 1 is a model diagram showing a state of polishing water stains 11 attached to a surface of glass 10 by a polisher on a surface of a base material 2 of which abrasive grains 1 are fixed by a binder 5.

As an abrasive grain according to an embodiment of the present invention as a base, an abrasive grain constituted of a granular porous body in which many primary grains are bonded with each other partially and in a state where pores are formed is used.

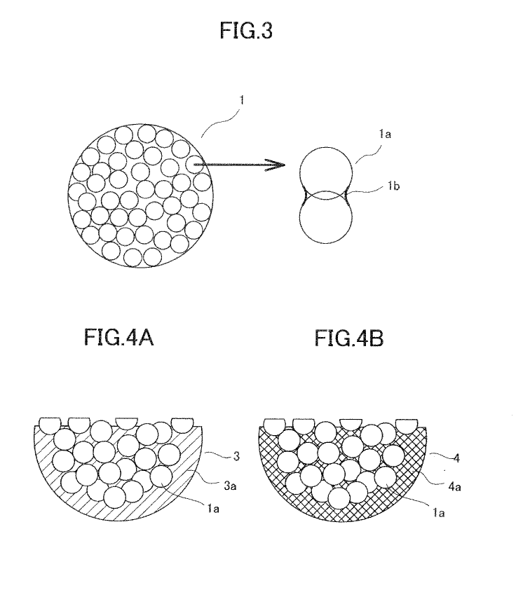

Such a granular porous body is shown in model form in FIG. 3. The granular porous body (abrasive grain 1) is a hard inorganic material, and is obtained such that many primary grains 1a aggregate and form secondary grains, and a heating treatment is performed at a temperature where a neck 1b in a shape of a hyperboloid of one sheet (a shape of an hourglass drum) is formed at a point where the primary grains are bonded with each other. Additionally, the many primary grains are bonded with each other partially and in a state where pores are formed. Such a granular porous body can be made by the method disclosed in Japanese Patent Application Publication No. 2011-231135, or the like.

A favorable average grain diameter of the abrasive grain according to the embodiment of the present invention is about 10 μm to 300 μm inclusive, and a more favorable range is about 40 μm to 100 μm inclusive. When the average grain diameter is too small, it is difficult to ensure a protrusion amount from an adhesive agent of an abrasive grain, and working efficiency becomes poor. On the other hand, when the average grain diameter is too large, there is a possibility that scratches caused by cleaning occur on an object to be polished and an object to be cleaned.

As a primary grain, zirconium oxide, cerium oxide (Ceria), silica, alumina, titanium oxide, or a mixture of those can be used. Each of those has high hardness, and therefore, a granular porous body constituted of those is an abrasive grain by which a high polishing effect or cleaning effect is obtained.

By using such primary grains, it is possible to form a secondary grain by a known method such as a sol-gel method, a spray dryer method, or the like. A heating treatment is performed on the secondary grain under a condition where a structure as shown in model form in FIG. 3 is obtained, and a granular porous body is obtained.

An abrasive grain as such a granular porous body is gradually abraded when it is used for polishing or cleaning. At this time, not only an outer surface of the abrasive grain which contacts an object to be polished (cleaned), but also each primary grain within the abrasive grain functions as a cutting blade.

As described above, it is understood that all primary grains 1 function as the cutting blade.

It is preferable that such an effect increase when an average grain diameter of a primary grain (a median diameter D50) is less than or equal to 5 μm in particular. Additionally, when the average grain diameter of the primary grain is in such an average grain diameter range, it is also possible to obtain an effect of preventing an occurrence of scratches or flaws on a polishing surface at the same time.

Moreover, when strength of compression failure of the abrasive grain is 1 MPa to 500 MPa inclusive, an appropriate abrasive speed is obtained in a case of polishing or cleaning, and therefore, a high polishing effect and an effect of preventing an occurrence of scratches with respect to a surface to be polished can be both achieved.

Furthermore, as to the above abrasive grain, the primary grains are bonded with each other without a binder, and therefore, clogging among the primary grains, and clogging among abrasive grains caused by a binder conventionally used when polishing do not occur. Accordingly, high polishing speed or high cleaning speed is maintained for a long period of time.

There are pores within the above abrasive grain, and therefore, it is possible to contain various types of functionalizing materials constituted of materials different from a material of a primary grain within the abrasive grain. In addition, when being abraded gradually by polishing or cleaning, it is possible to gradually release the contained functionalizing materials within the abrasive grain outside. Here, functionalizing functions include a function of decomposing a water stain, oil, and the like, a cleaning function, a function of preventing a mirror, or glass from fogging, and the like.

In order to thus contain the functionalizing materials within the abrasive grain, an abrasive grain as a porous body is immersed into a solution in which a functionalizing material is dissolved, the abrasive grain is taken out from the solution, and dried. In this case, a decompression treatment, a pressure treatment, a heating treatment, and a cooling treatment can be performed each alone, in combination concurrently, or in order. By thus containing the functionalizing materials within the abrasive grain, it is possible to make the abrasive grain to be an abrasive grain which releases functionalizing materials outside as polishing is performed by the abrasive grain. Note that in a case where a functionalizing material is liquid, it is possible to contain the functionalizing material within an abrasive grain by directly immersing the abrasive grain in the functionalizing material without using a solution as described above.

As a functionalizing material, a material which is released outside from inside of the abrasive grain when contacting liquid including water can be included. Additionally, when the abrasive grain contacts liquid including water, the material may be a material which reacts with the water and generates a reactant which is released outside from inside of the abrasive grain, and furthermore, both may be used in combination as necessary.

As the former, various types of water-soluble acids such as citric acid, acetic acid and the like, a surfactant, and a material having hydrophilicity to a glass surface, for example, polyvinyl alcohol, a fluorine or silicone water-soluble water-repellent material, or the like can be included. And as the latter, sodium hydrogen carbonate (sodium bicarbonate), various types of solid chlorine agents such as a bleaching powder, and the like can be included.

Here, in FIG. 4A, a model diagram showing a use state of an abrasive grain 3 according to the embodiment of the present invention which contains citric acid as a functionalizing material 3a is shown, and in FIG. 4B, a model diagram showing a use state of an abrasive grain 4 according to the embodiment of the present invention which contains sodium hydrogen carbonate as a functionalizing material 4a is shown.

Additionally, a wetting agent, a surface-reforming agent (wettability-improving agent for water repellency, or the like), or the like may be used as a functionalizing material which is released, as an abrasive grain is abraded, regardless of the existence or absence of water, and also those may be combined with the functionalizing material. The above cases are also included in the abrasive grain according to the embodiment of the present invention.

In a case of using the abrasive grain according to the embodiment of the present invention for polishing or cleaning, a plurality of kinds of abrasive grains may be used in combination. For example, a plurality of kinds of abrasive grains containing one kind of a functionalizing material or a plurality of different kinds of functionalizing materials different from the primary grains can be used for polishing or cleaning concurrently, or in combination in order.

Here, as described above, a combination of particularly favorable functionalizing materials for removal of a water stain attached to a surface of a mirror or glass is a combination of acids, preferably a combination of acids which are environment-friendly and comparatively weak acids such as citric acid, or the like, and sodium hydrogen carbonate which reacts with water and generates carbonic acid.

However, when those are dissolved in water concurrently, generation of carbon dioxide starts, and therefore, it is difficult to contain those functionalizing materials within an abrasive grain at the same time. In this case, by producing an abrasive grain containing acid and an abrasive grain containing a functionalizing material separately and using both in combination when polishing or cleaning, it is possible to perform effective polishing or cleaning.

Here, as such an example, a production method of the abrasive grain containing citric acid 3 and the abrasive grain containing sodium hydrogen carbonate 4 will be explained with reference to FIGS. 5A and 5B.

The production method of the abrasive grains individually illustrated includes at least two steps, which are an impregnating step where a granular porous body in which many primary grains are bonded with each other partially and in a state where pores are formed is impregnated into a solution in which a functionalizing material is dissolved, and a drying step where after the impregnating step, the porous body impregnated into the solution is taken out from the solution and dried.

As shown in FIG. 5A, firstly, an abrasive grain 1 is immersed into an aqueous solution 21 of citric acid in a container 20 to contain a functionalizing material. At this time, the whole container 20 is left in a reduced-pressure state of approximately 300 hPa for ten minutes. And then, it is returned to an ordinary pressure state, the abrasive grain 1 is taken out from the aqueous solution, and dried naturally, or in a constant temperature oven, and water in the abrasive grain 1 is evaporated and dried for about an hour. In the above manner, an abrasive grain 3 according to the embodiment of the present invention which contains citric acid is obtained.

Likewise, as shown in FIG. 5B, an abrasive grain 1 is immersed into an aqueous solution 31 of sodium hydrogen carbonate in a container 30. The same as the above is performed subsequently, and then an abrasive grain 4 according to the embodiment of the present invention which contains sodium hydrogen carbonate is obtained.

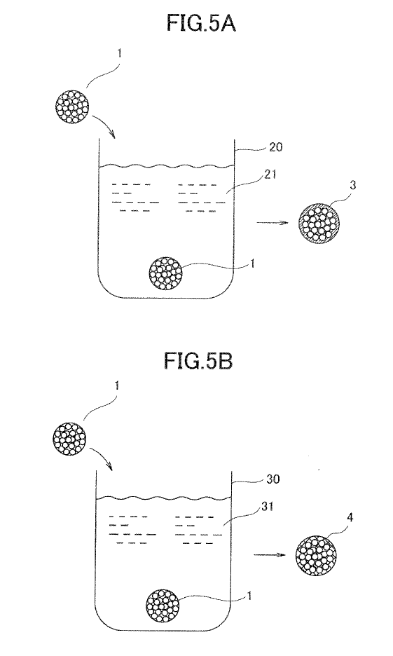

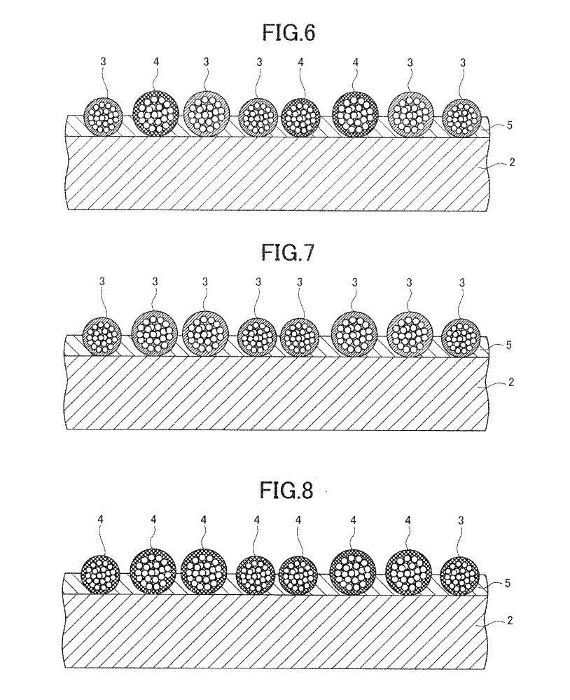

For example, as illustrated in FIG. 6, a resin film is used as a base material 2, and on one surface (a polishing surface) of the resin film, the abrasive grains 3 and 4 are fixed in a mixed state by a binder 5, which can be used as a polisher (polishing film). As a resin constituted of the resin film, polycarbonate, polyethylene naphthalate, polypropylene, polymethyl methacrylate, polyethylene telephthalate, or the like is included. Above all, polyethylene telephthalate is preferable, because it has variations in thickness, mechanical intensity, and excellent flexibility.

Here, a ratio of the abrasive grain 3 containing citric acid within and the abrasive grain 4 containing sodium hydrogen carbonate within is preferably in a range of 1:1 to 1:5 (including a boundary value) as the mass of the contained citric acid and sodium hydrogen carbonate. That is, the ratio is preferably in this range because removal of a water stain attached to a mirror, glass, or the like is effectively performed, and it is more preferably in a range of 1:1 to 1:2.

Note that as shown in FIG. 7, a polishing film (polisher) which is a film on which the abrasive grain 3 containing citric acid within is fixed alone can be used for, for example, polishing or cleaning a mirror or glass to which a water stain is attached. Here, an effect of the polishing film for removal of a water stain attached to glass is slightly low, compared with that of the polishing film shown in FIG. 6; however, it is possible to use it for polishing or cleaning the mirror or glass to which the water stain is attached. Additionally, as shown in FIG. 8, also by a polishing film which is a film on which the abrasive grain 4 containing sodium hydrogen carbonate within is fixed alone, an effect of cleaning an oil stain, finger marks, or the like on a glass surface can be obtained.

As to the polisher according to an embodiment of the present invention, as described above, it is only necessary to fix an abrasive grain containing a functionalizing material on a polishing surface of the polisher, and as such a polisher, for example, a polishing film, a polishing sheet, tape, pad, roll, belt, or the like can be included.

The preferred embodiments of the present invention have been explained so far; however, the abrasive grain, polisher, and production method of the abrasive grain according to the embodiments of the present invention are not limited to the formation of the above-described embodiments.

A person skilled in the art can appropriately modify the abrasive grain, polisher, and production method of the abrasive grain according to the embodiments of the present invention in accordance with generally known knowledge. As long as the formation of the abrasive grain, polisher, and production method of the abrasive grain according to the embodiments of the present invention is included, such modification is included in a category of the present invention.

Hereinafter, although each illustration is omitted, examples of abrasive grains, polishers, and production methods of the abrasive grains according to the embodiments of the present invention will be explained.

Note that in the examples, a number-average granular diameter is measured in a dry method by using a laser diffraction/scattering-type grain size distribution measuring device LA-920 manufactured by HORIBA, Ltd., and a granular diameter at which a value of 50% of integrated values of frequency in distribution is shown is taken as an average granular diameter (usually, referred to as a meridian diameter D50).

Additionally, a strength of compression failure test is performed based on a report by Hiramatsu, Oka, and Kiyama (Journal of the Mining and Metallurgical Institute of Japan, 81, 1024 (1965)) by using a microcompression testing machine MCTM500PC manufactured by SHIMADZU CORPORATION.

As a test condition, test loads are 10 mN to 1000 mN, a loading rate is 0.446 mN/second. Compression is performed with respect to an abrasive grain to be measured by using a flat indenter, and strength is measured when the abrasive grain is destroyed by the compression. A relationship between compression displacements and loads is illustrated in a graph, a load value at a bending part of a curve of the graph (a curving part shows destruction) is read, and strength of compression failure is calculated from this value.

A polyvinyl alcohol-water mixture is added to ultrafine zirconium oxide (Zro₂) powders having granular diameters of 50 nm to 60 nm to form a slurry, the slurry is sprayed by a spray dryer, and secondary grains α having a number-average granular diameter of 50 μm are obtained.

With respect to the secondary grains α, a heating treatment is performed in an electric furnace. By the heating treatment, the polyvinyl alcohol used as a binder when forming the secondary grains as described above is completely removed.

Here, in accordance with a condition previously researched, the temperature and time of the heating treatment are adjusted such that diameters of primary grains, which function as cutting blade-forming grains, contained within a porous body when being used as an abrasive grain are less than or equal to 5 μm.

After the heating treatment, regarding an obtained abrasive grain β, when a cross-section of the obtained abrasive grain β is observed by a scanning electron microscope, partially and among the primary grains of the obtained abrasive grain β, pores are formed. The obtained abrasive grain β is confirmed to be a granular porous body in which a neck in a shape of a hyperboloid of one sheet (a shape of an hourglass drum) is formed at a bonded point of the primary grains.

Additionally, a number-average grain diameter of the abrasive grain β is 60 μm, strength of compression failure is 60 MPa to 90 MPa on average, and a BET pore specific surface area is 300,000 cm²/g on average.

### Example 1

With respect to the abrasive grain β, by performing those treatments as described above with reference to FIGS. 5A and 5B, an abrasive grain β1 containing citric acid within and an abrasive grain β2 containing sodium hydrogen carbonate within are made. At this time, a citric acid aqueous solution of 50 mass % and a sodium hydrogen carbonate aqueous solution of 10 mass % are used. A contained amount of citric acid (first functionalizing material) of the abrasive grain β1 is 1.2 mass %, and a contained amount of sodium hydrogen carbonate (second functionalizing material) of the abrasive grain β2 is 0.5 mass %.

Those abrasive grains β1 and β2 are mixed with a liquid urethane resin (binder) so as to be 1:2 in mass ratio, and after additionally adding a solvent for a urethane resin and adjusting viscosity, agitated and mixed by using an agitator. An agitating condition of 50 RPM at room temperature is used. A ratio of the mass of the citric acid and the mass of the sodium hydrogen carbonate contained within those abrasive grains in mass ratio is 1:2.

Then, on one surface of a base material (a polyethylene terephthalate film of 75 μm in thickness) of the mixture solution, by using a wire bar coater (manufactured by TESTER SANGYO Co., Ltd. P1-1210), the abrasive grains are applied to be 75 g/m² in mass per unit area, and then dried for about one hour at approximately 60 degrees Celsius, and as shown in model form in FIG. 6, a polisher (polishing film) A is obtained.

By using the thus obtained polishing film A, removal of a water stain attached to a mirror is performed manually, with adding water.

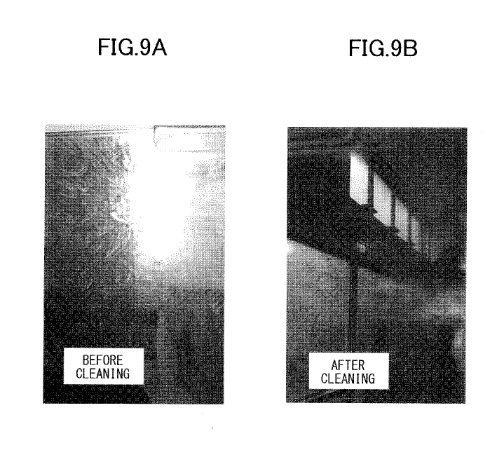

FIG. 9A shows a photograph of the mirror before using polishing films in the examples, and FIG. 9B shows a photograph of the mirror after removing the water stain.

The removal of the water stain is performed with less force, compared with a case where a polishing film B according to a conventional technique on which an abrasive grain β which does not contain a functionalizing component is fixed in the same mass per unit area as the abrasive grains of the polishing film A of Example 1, and is extremely easy, and an operation time is reduced by half.

The reason why such an effect is obtained is inferred to be because in a case of using the polishing film A, calcium carbonate of the water stain is dissolved by carbonated water generated by a reaction expressed by the following chemical formula (1), and therefore, the water stain is softened.

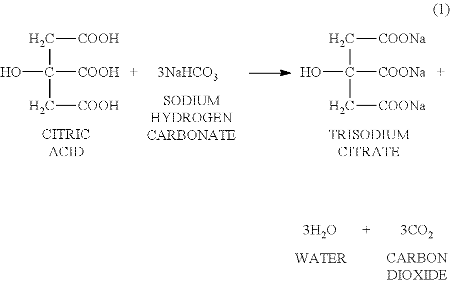

In addition, although the water supplied little by little is initially pH-neutral, it is confirmed that until the polishing operation is completed, the pH of water attached to the mirror during a polishing operation is 5.5 and maintained acidified in an approximately constant manner. It is proved that the functionalizing component is gradually released from inside of the polishing film A.

Note that when visually looking at the mirror after the polishing operation, it is confirmed that no scratches or flaws occur on a surface of the mirror in a case of using the polishing film A of Example 1.

Additionally, in a case where a polishing effect remains in the polishing film A of Example 1, the polishing film A can be used again by drying it after use, and also in this case a high polishing effect can be obtained again.

### Example 2

With the exception of using only the abrasive grain β1 containing citric acid within, a polishing film C, for example, as shown in model form in FIG. 7, is made in the same manner as the above Example 1, and removal of a water stain attached to glass is performed manually, with adding water. Then, the removal of the water stain can be performed easily with a small force. Additionally, on a surface of the glass, no scratches or flaws occur.

This is inferred to be because, as expressed by the following chemical formula (2), calcium carbonate as a main component of the water stain reacts with citric acid, and therefore, the water stain is softened, and easily removed with a small force.

3CaCO₃+2C₆H₈O₇→Ca₃(C₆H₅O₇)₂+3H₂CO₃ (2)

In a case of using the polishing film C as described above, due to a chemical action of citric acid, calcium carbonate as the main component of the water stain is dissolved and polished in an easily-removable state, and therefore, it is possible to remove the water stain with high efficiency and without damage to the glass.

Note that even when the polishing film C is used in a state where a polishing ability remains therein after drying, for example, one week later, the polishing film C maintains an effect of dissolving calcium carbonate, and therefore, a polishing operation is easy.

### Example 3

A water-soluble silicone water repellent is contained within the above abrasive grain β.

That is, by using an aqueous solution in which Fluoro Surf manufactured by FluoroTechnology Co., LTD. is dissolved to be 20 mass %, an abrasive grain β3 containing the silicone water repellent is made in the same manner as described above. An amount of the silicone water repellent contained within the abrasive grain β3 is 1.5 mass %. Additionally, it is confirmed that the silicone water repellent is contained within the abrasive grain β3 in the same manner as described above.

A polishing film D is obtained in the same manner as the above Example 1, except that mass per unit area of the abrasive grains β1 and β2 is ⅔, the abrasive grain β3 is used in combination, and total mass per unit area of the abrasive grains becomes equal.

When an operation of removing a water stain of a mirror is performed in the same manner as a case of using the polishing film A of Example 1 by using the polishing film D, the operation is as easy as the case of using the polishing film A, and no scratches or flaws occur on a surface of the mirror.

After the operation, attachment of the water stain on the mirror surface no longer exists. This is because the silicone water repellent is supplied on the surface of the mirror from the abrasive grain β3 of the polishing film D, and a water-repellent coating film is formed.

### Example 4

Polyvinyl alcohol is contained within the above abrasive grain β.

That is, by using an aqueous solution in which POVAL manufactured by Shin-Etsu Astech Co., Ltd. is dissolved to be 50 mass %, an abrasive grain β4 containing the polyvinyl alcohol is made in the same manner as described above. An amount of the polyvinyl alcohol contained within the abrasive grain β4 is 5 mass %. Additionally, it is confirmed that the polyvinyl alcohol is contained within the abrasive grain β4 in the same manner as described above.

However, except that mass per unit area of the abrasive grains β1 and β2 is ⅔, the abrasive grain β4 is used in combination, and total mass per unit area of the abrasive grains becomes equal, a polishing film E is obtained in the same manner as the above Example 1.

When an operation of removing a water stain of a mirror is performed in the same manner as the case of using the polishing film A of Example 1 by using the polishing film E, the operation is as easy as the case of using the polishing film A, and no scratches or flaws occur on a surface of the mirror.

After the operation, occurrence of dew condensation and fogging no longer exists. This is because the polyvinyl alcohol is supplied from the abrasive grain β4 of the polishing film E to the surface of the mirror, and a hydrophilic coating film is formed.

An abrasive grain according to an embodiment of the present invention is an abrasive grain constituted of a granular porous body in which many primary grains are bonded with each other partially and in a state where pores are formed, and within the abrasive grain, a functionalizing material constituted of a material different from the primary grains is contained, and therefore, it is possible to provide an excellent polisher which easily removes a tough stain such as a water stain attached to a glass surface, which is difficult to be cleaned or removed by a conventional cleaning agent or polisher, with a small force.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. An abrasive grain, comprising:
a granular porous body in which many primary grains are bonded with each other partially, and in a state where pores are formed,
wherein a functionalizing material constituted of a material different from the primary grains is contained within the abrasive grain.

2. The abrasive grain according to claim 1, wherein the functionalizing material is released outside, as polishing is performed by the abrasive grain.

3. The abrasive grain according to claim 2, wherein when contacting liquid including water, the functionalizing material is a material which is released outside from inside of the abrasive grain.

4. The abrasive grain according to claim 3, wherein the functionalizing material is one or more than one material selected from a water-soluble acid, a fluorine water-soluble water-repellent material, a silicone water-repellent material, and polyvinyl alcohol.

5. The abrasive grain according to claim 1, wherein when the abrasive grain contacts contacting liquid including water, the functionalizing material is a material which reacts with the water and generates a reactant which is released outside from inside of the abrasive grain.

6. The abrasive grain according to claim 5, wherein the functionalizing material is sodium hydrogen carbonate.

7. The abrasive grain according to claim 1, wherein the functionalizing material is constituted of a first functionalizing material which is released outside from inside of the abrasive grain, when the abrasive grain contacts liquid including water, and a second functionalizing material which reacts with the water, and generates a reactant which is released outside from inside of the abrasive grain.

8. The abrasive grain according to claim 7, wherein the first functionalizing material is a water-soluble acid, and the second functionalizing material is sodium hydrogen carbonate.

9. A polisher, comprising:
the abrasive grain according to claim 1,
wherein the abrasive grain is fixed on a polishing surface of the polisher.

10. A production method of the abrasive grain according to claim 1, at least comprising the steps in the following order of:
impregnating a granular porous body in which many primary grains are bonded with each other partially and in a state where pores are formed into a solution in which a functionalizing material is dissolved; and
drying the solution-impregnated porous body which is taken out from the solution.
